(19) United States
(12) Patent Application Publication
(10) Pub. No.: US 2024/0160384 A1
(43) Pub. Date: May 16, 2024

(54) CONTROLLER OF STORAGE DEVICE ADAPTIVELY ADJUSTING OPERATION PERFORMANCE AND METHOD OF OPERATING THE CONTROLLER

(71) Applicant: SK hynix Inc., Gyeonggi-do (KR)

(72) Inventor: Youn Won PARK, Gyeonggi-do (KR)

(21) Appl. No.: 18/304,348

(22) Filed: Apr. 21, 2023

(30) Foreign Application Priority Data
Nov. 10, 2022 (KR) 10-2022-0149962

(51) Int. Cl. G06F 3/06; G06F 12/02

(52) U.S. Cl. CPC G06F 3/0658; G06F 3/061; G06F 3/0659; G06F 3/0673; G06F 12/0223; G06F 2212/1016

(57) ABSTRACT

A controller includes a clock frequency determiner configured to determine a type of a read operation corresponding to a read request based on the read request received from a host, and to determine a clock frequency according to the type, a clock generator configured to generate a clock according to the determined clock frequency, and a command generator configured to generate a read command corresponding to the read request using the clock.

### CROSS-REFERENCE TO RELATED APPLICATION

The present application claims priority under 35 U.S.C. § 119(a) to Korean patent application number 10-2022-0149962, filed on Nov. 10, 2022, the entire disclosure of which is incorporated herein by reference.

### BACKGROUND

### 1. Field of Invention

Embodiments of the present disclosure relate to an electronic device, and more particularly, to a controller of a storage device adaptively adjusting operation performance and a method of operating the controller. The storage device may include a memory device and a controller controlling the memory device. The controller according to the present disclosure may adjust operation performance by adaptively adjusting a clock frequency or a power voltage value.

### 2. Description of Related Art

A storage device is a device that stores data under control of a host device such as a computer, a smart phone, or a smart pad. The storage device includes a device that stores data in a magnetic disk such as a hard disk drive (HDD), a device that stores data in a semiconductor memory such as a solid state drive (SSD), or a memory card, in particular, a nonvolatile memory.

The storage device may include a semiconductor memory device in which data is stored and a memory controller controlling a data storage operation of the semiconductor memory device. The semiconductor memory device may be classified into a volatile memory and a nonvolatile memory. Here, the nonvolatile memory may include a read only memory (ROM), a programmable ROM (PROM), an electrically programmable ROM (EPROM), an electrically erasable and programmable ROM (EEPROM), a flash memory, a phase-change RAM (PRAM), a magnetic RAM (MRAM), a resistive RAM (RRAM), a ferroelectric RAM (FRAM), and the like.

As performance of the storage device improves, required power also increases in proportion to the performance. In particular, in a mobile application, a need to efficiently manage power consumption of the storage device is becoming gradually important. A factor affecting the power consumption of the storage device may include a clock frequency inside the controller and a power voltage supplied to the controller. Therefore, the power consumption of the storage device may be adjusted by controlling the clock frequency or the power voltage.

### SUMMARY

Embodiments of the present disclosure provide a controller and a method of operating the same capable of reducing power consumption of a storage device by controlling a clock frequency or a power voltage according to a characteristic of a read operation.

According to an embodiment of the present disclosure, a controller includes a clock frequency determiner configured to determine a type of a read operation corresponding to a read request based on the read request received from a host, and to determine a clock frequency according to the type, a clock generator configured to generate a clock according to the determined clock frequency, and a command generator configured to generate, using the clock, a read command corresponding to the read request.

In an embodiment, the type of the read operation is one of a random read operation and a sequential read operation.

According to another embodiment of the present disclosure, a controller includes an operation voltage determiner configured to determine a type of a read operation corresponding to a read request based on the read request received from a host, and determine an operation voltage according to the type, a voltage generator configured to generate a power voltage according to the determined operation voltage, and a command generator configured to generate, using the power voltage, a read command corresponding to the read request.

In an embodiment, the type of the read operation is one of a random read operation and a sequential read operation.

According to still another embodiment of the present disclosure, a method of operating a controller includes receiving a read request from a host, determining a type of a read operation to be performed in response to the read request, and determining, based on the determination, at least one of a clock frequency and a power voltage value to be used for command generation.

According to still another embodiment of the present disclosure, an operating method of a controller includes setting a clock frequency to a first value in response to a sequential read request and to a second value in response to a random read request, and generating, according to the set clock frequency, a command to control a memory device to perform a read operation.

The first value is less than the second value. The present technology may provide a controller and a method of operating the same capable of reducing power consumption of a storage device by controlling a clock frequency or a power voltage according to a characteristic of a read operation.

### BRIEF DESCRIPTION OF THE DRAWINGS

FIG. 1 is a block diagram illustrating a storage device according to an embodiment of the present disclosure.

FIG. 2 is a detailed block diagram illustrating a controller according to an embodiment of the present disclosure.

FIG. 3 is a flowchart illustrating a method of operating a controller according to an embodiment of the present disclosure.

FIG. 4 is a detailed flowchart illustrating operation S130 of FIG. 3 according to an embodiment of the present disclosure.

FIG. 5 is a diagram illustrating a data structure configuring a read request received from a host according to an embodiment of the present disclosure.

FIGS. 6A and 6B are diagrams illustrating a method of determining a type of a read operation corresponding to the received read request by a method shown in FIG. 4 according to an embodiment of the present disclosure.

FIG. 7 is a detailed flowchart illustrating operation S130 of FIG. 3 according to another embodiment of the present disclosure.

FIG. 8 is a diagram illustrating a method of determining the type of the read operation corresponding to the received read request by a method shown in FIG. 7 according to an embodiment of the present disclosure.

FIG. 9 is a detailed flowchart illustrating operation S150 of FIG. 3 according to an embodiment of the present disclosure.

FIGS. 10A and 10B are detailed block diagrams illustrating a controller generating different clock frequencies according to the type of the read operation corresponding to the received read request according to an embodiment of the present disclosure.

FIG. 11 is waveforms illustrating clocks shown in FIGS. 10A and 10B according to an embodiment of the present disclosure.

FIG. 12 is a detailed block diagram illustrating a controller according to another embodiment of the present disclosure.

FIG. 13 is a flowchart illustrating a method of operating a controller according to another embodiment of the present disclosure.

FIG. 14 is a detailed flowchart illustrating operation S650 of FIG. 13 according to another embodiment of the present disclosure.

FIG. 15 is a detailed block diagram illustrating a controller according to still another embodiment of the present disclosure.

FIG. 16 is a detailed diagram illustrating a controller according to an embodiment of the present disclosure.

### DETAILED DESCRIPTION

Specific structural or functional descriptions of embodiments according to the concept which are disclosed in the present specification are illustrated only to describe the embodiments according to the concept of the present disclosure. The embodiments according to the concept of the present disclosure may be carried out in various forms and should not be construed as being limited to the embodiments described in the present specification.

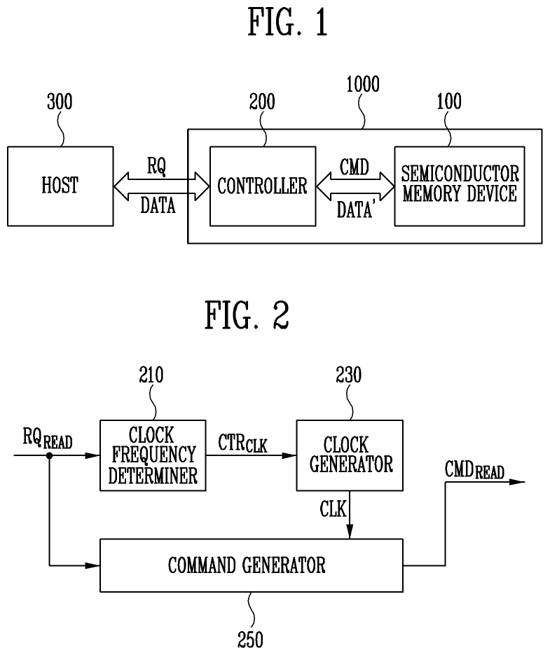

FIG. 1 is a block diagram illustrating a storage device according to an embodiment of the present disclosure.

Referring to FIG. 1, the storage device 1000 may include a semiconductor memory device 100 and a controller 200.

The storage device 1000 may be a device that stores data under control of a host 300.

The host 300 may be a mobile phone, a smart phone, an MP3 player, a laptop computer, a desktop computer, a game machine, a TV, or a tablet PC. In an embodiment, the host 300 may be a computing system included in a mobile device driven by an internal combustion engine, a hybrid drive system, and/or an electric motor. For example, the host 300 may be a computing system included in a mobile device such as a vehicle, a ship, an unmanned drone, a manned drone, an electric bicycle, a motorcycle, an electric wheel, or an electric kickboard.

The storage device 1000 may be manufactured as any of various types of storage devices according to a host interface that is a communication method with the host 300. For example, the storage device 1000 may be configured as any of various types of storage devices such as an SSD, a multimedia card in a form of an MMC, an eMMC, an RS-MMC and a micro-MMC, a secure digital card in a form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, a smart media card, and a memory stick.

The storage device 1000 may be manufactured as any of various types of packages. For example, the storage device 1000 may be manufactured as any of various package types, such as a package on package (POP), a system in package (SIP), a system on chip (SOC), a multi-chip package (MCP), a chip on board (COB), a wafer-level fabricated package (WFP), and a wafer-level stack package (WSP).

The semiconductor memory device 100 may store data. The semiconductor memory device 100 operates in response to control of the controller 200. In an embodiment, the semiconductor memory device 100 may be a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), a NAND flash memory, a vertical NAND flash memory, a NOR flash memory, a resistive random access memory (RRAM), a phase-change random access memory (PRAM), a magneto-resistive random access memory (MRAM), a ferroelectric random access memory (FRAM), a spin transfer torque random access memory (STT-RAM), or the like. In the present specification, for convenience of description, the semiconductor memory device 100 is a NAND flash memory.

The semiconductor memory device 100 may be implemented as a two-dimensional array structure or a three-dimensional array structure. The present disclosure may be applied not only to a flash semiconductor memory device in which a charge storage layer is configured of a conductive floating gate (FG), but also to a charge trap flash (CTF) in which the charge storage layer is configured of an insulating film.

In an embodiment, the semiconductor memory device 100 may operate in a single level cell (SLC) method in which one data bit is stored in one memory cell. Alternatively, the semiconductor memory device 100 may operate in a method of storing at least two or more data bits in one memory cell.

The semiconductor memory device 100 is configured to receive a command CMD and an address from the controller 200 and access an area selected by the address in the memory cell array. That is, the semiconductor memory device 100 may perform an operation corresponding to the command CMD on the area selected by the address. For example, the semiconductor memory device 100 may perform a write operation (program operation), a read operation, or an erase operation according to the received command CMD. For example, when a program command is received, the semiconductor memory device 100 may program data to the area selected by the address. When a read command is received, the semiconductor memory device 100 may read data from the area selected by the address. When an erase command is received, the semiconductor memory device 100 may erase data stored in the area selected by the address.

In an embodiment, the number of semiconductor memory devices 100 may be plural number. That is, a plurality of semiconductor memory devices may be included in the storage device 1000. The plurality of semiconductor memory devices may be connected to the controller 200 through channels and communicate with the controller 200 through the channels. For example, the controller 200 may instruct an operation to each of the plurality of semiconductor memory devices, and the plurality of semiconductor memory devices may perform an operation corresponding to the instruction of the controller 200. In addition, each of the plurality of semiconductor memory devices may output a result of performing the operation to the controller 200.

The controller 200 may control an overall operation of the storage device 1000.

When a power voltage is applied to the storage device 1000, the controller 200 may execute firmware (FW). When the semiconductor memory device 100 is a flash semiconductor memory device, the controller 200 may operate firmware such as a flash translation layer (FTL) for controlling communication between the host 300 and the semiconductor memory device 100.

In an embodiment, the controller 200 may include firmware (not shown) that may receive data and a logical block address (LBA) from the host 300 and convert the LBA into a physical block address (PBA) indicating an address of memory cells in which data included in the semiconductor memory device 100 is to be stored. In addition, the controller 200 may store a logical-physical address mapping table configuring a mapping relationship between the LBA and the PBA in a buffer memory.

The controller 200 may control the semiconductor memory device 100 to perform the program operation, the read operation, the erase operation, or the like according to a request RQ of the host 300. For example, when a program request and data DATA are received from the host 300, the controller 200 may generate a program command based on the program request, and may provide the program command, the PBA, and data DATA′ to the semiconductor memory device 100. When a read request is received from the host 300 together with the LBA, the controller 200 may generate the read command based on the read request, select a PBA corresponding to the LBA, and then provide the read command and the PBA to the semiconductor memory device 100. The semiconductor memory device 100 may perform the read operation based on the read command and the PBA, and transfer the read data DATA′ to the controller 200. The controller 200 may transfer the data DATA to the host 300.

When an erase request is received from the host 300 together with the LBA, the controller 200 may change the erase request into an erase command, select a PBA corresponding to the LBA, and then provide the erase command and the PBA to the semiconductor memory device 100.

In an embodiment, the controller 200 may generate and transmit the program command, the address, and the data to the semiconductor memory device 100 without the request from the host 300. For example, the controller 200 may provide the command, the address, and the data DATA′ to the semiconductor memory device 100 to perform background operations such as a program operation for wear leveling and a program operation for garbage collection.

In an embodiment, the storage device 1000 may further include a buffer memory (not shown). The controller 200 may control data exchange between the host 300 and the buffer memory (not shown). Alternatively, the controller 200 may temporarily store system data for controlling the semiconductor memory device 100 in the buffer memory. For example, the controller 200 may temporarily store data input from the host 300 in the buffer memory, and then transmit the data temporarily stored in the buffer memory to the semiconductor memory device 100.

In various embodiments, the buffer memory may be used as an operation memory and a cache memory of the controller 200. The buffer memory may store codes or commands executed by the controller 200. Alternatively, the buffer memory may store data processed by the controller 200.

In an embodiment, the buffer memory may be implemented as a dynamic random access memory (DRAM) such as a double data rate synchronous dynamic random access memory (DDR SDRAM), a DDR4 SDRAM, a low power double data rate4 (LPDDR4) SDRAM, a graphics double data rate (GDDR) SDRAM, a low power DDR (LPDDR), a Rambus dynamic random access memory (RDRAM), or a static random access memory (SRAM).

In various embodiments, the buffer memory may be connected from an outside of the storage device 1000. In this case, the volatile semiconductor memory devices connected to the outside of the storage device 1000 may serve as the buffer memory.

In an embodiment, the controller 200 may control at least two or more semiconductor memory devices. In this case, the controller 200 may control the semiconductor memory devices according to an interleaving method in order to improve operation performance.

The host 300 may communicate with the storage device 1000 using at least one of various communication standards or interfaces such as a universal serial bus (USB), a serial AT attachment (SATA), a serial attached SCSI (SAS), a high speed interchip (HSIC), a small computer system interface (SCSI), a peripheral component interconnection (PCI), a PCI express (PCIe), a nonvolatile memory express (NVMe), a universal flash storage (UFS), a secure digital (SD), a multi-media card (MMC), an embedded MMC (eMMC), a dual in-line memory module (DIMM), a registered DIMM (RDIMM), and a load reduced DIMM (LRDIMM).

As performance of the storage device 1000 improves, data transmission speed between the host 300 and the storage device 1000 also increases. In order to accommodate the increased data transmission speed, a data processing speed required by the controller 200 is also increasing.

For example, in universal flash storage (UFS) version 4.0, 400K of input/output per second (IOPS) is required for a 4 KB size of random read operation. To this end, the controller 200 is required to process the read request received from the host 300 within 2.5 microseconds (μs).

In order to reduce a request performance time, that is, a time required to generate the read command to be transferred to the semiconductor memory device 100 based on the read request received from the host 300, an operation frequency inside the controller 200 tends to increase. As the operation frequency of the controller 200 increases, power consumed by the controller 200 also increases. In a mobile application where a power use is limited, an increase of the power consumed by the controller 200 becomes a factor that weakens product competitiveness.

The controller 200 according to an embodiment of the present disclosure determines a clock frequency used inside the controller 200 according to a characteristic of the read operation of the storage device 1000 corresponding to the read request received from the host 300. Accordingly, the power consumed by the controller 200 may be minimized while satisfying a performance requirement according to the characteristic of the read operation.

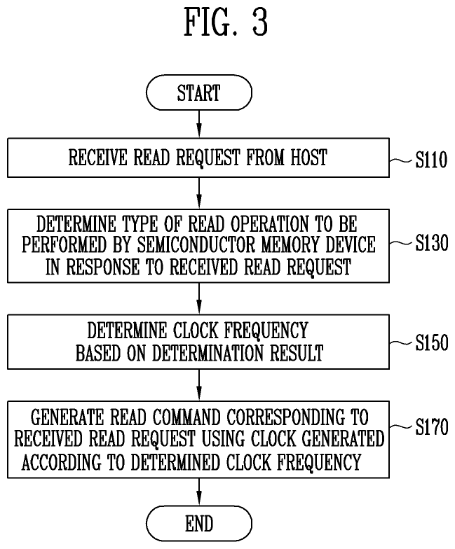

FIG. 2 is a detailed block diagram illustrating a controller according to an embodiment of the present disclosure. FIG. 3 is a flowchart illustrating a method of operating a controller according to an embodiment of the present disclosure. Hereinafter, with reference to FIGS. 2 and 3, the controller 200 and a method of operating the same according to an embodiment of the present disclosure are described.

Referring to FIG. 2, the controller 200 according to an embodiment of the present disclosure may include a clock frequency determiner 210, a clock generator 230, and a command generator 250. Referring to FIG. 3, a method of operating a controller according to an embodiment of the present disclosure includes receiving a read request from a host (S110), determining a type of a read operation to be performed by a semiconductor memory device in response to the received read request (S130), determining a clock frequency based on a determination result (S150), and generating a read command corresponding to the received read request using a clock generated according to the determined clock frequency (S170).

In FIG. 2, the clock frequency determiner 210 determines a type of a corresponding read operation based on the read request RQ_{READ} received (S110) from the host 300 (S130), and determines the clock frequency according to the determination result (S150). The clock frequency determiner 210 generates a control signal CTR_{CLK} for controlling an operation of the clock generator 230 according to the determined clock frequency.

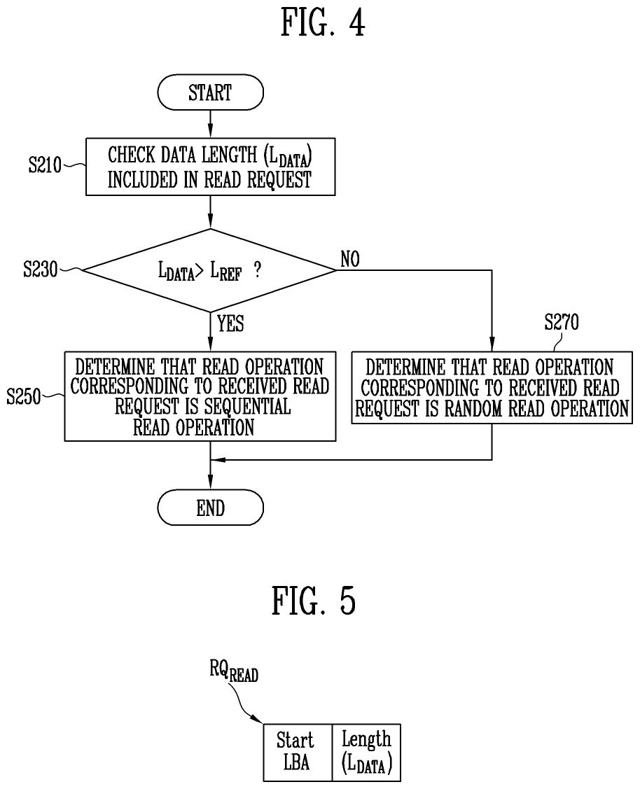

More specifically, the clock frequency determiner 210 analyzes the read request RQ_{READ} received from the host 300 and determines whether the read operation corresponding to the read request RQ_{READ} is a random read operation or a sequential read operation. Specific embodiments in which the clock frequency determiner 210 determines whether the corresponding read operation is the random read operation or the sequential read operation based on the read request RQ_{READ} (S130) are described with reference to FIGS. 4 to 8.

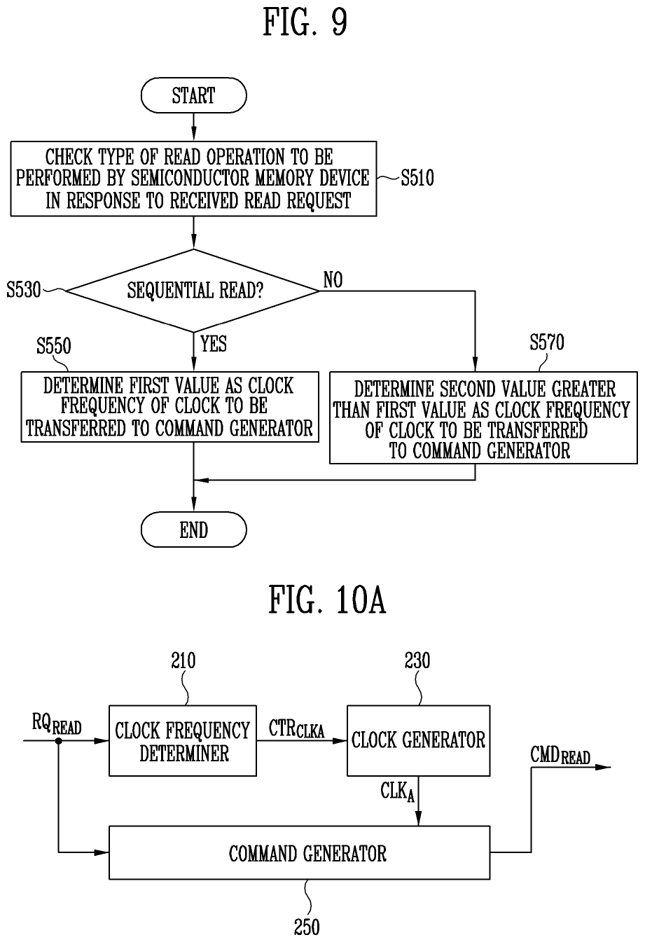

The clock frequency determiner 210 determines a clock frequency value based on whether the read operation corresponding to the read request RQ_{READ} is the random read operation or the sequential read operation. A specific embodiment in which the clock frequency determiner 210 determines the clock frequency value is described with reference to FIG. 9. The clock frequency determiner 210 generates the control signal CTR_{CLK} for controlling the clock generator 230 to generate a clock CLK having the determined clock frequency value.

The clock generator 230 generates the clock CLK based on the received control signal CTR_{CLK}. The generated clock CLK is transferred to the command generator 250.

The command generator 250 receives the read request RQ_{READ} and the clock CLK. The command generator 250 generates the read command corresponding to the received read request RQ_{READ} using the received clock (S170).

Referring to FIGS. 2 and 3, the controller according to an embodiment of the present disclosure determines the type of the corresponding read operation based on the read request RQ_{READ} received from the host 300 and determines clock frequency used for generation of the read command CMD_{READ} according to the type of the read operation. Therefore, a frequency of the clock transferred to the command generator 250 may be optimized according to the type of the read operation. As a result, power consumed by the controller 200 may be minimized while satisfying a performance requirement according to the characteristics of the read operation.

FIG. 4 is a detailed flowchart illustrating operation S130 of FIG. 3 according to an embodiment of the present disclosure. FIG. 5 is a diagram illustrating a data structure configuring the read request received from the host 300 according to an embodiment of the present disclosure. Hereinafter, an embodiment of operation S130 of FIG. 3 is described with reference to FIGS. 4 and 5 together.

Referring to FIG. 4, operation S130 of FIG. 3 includes checking the data length L_{DATA} included in the read request (S210) and determining whether the checked data length L_{DATA} is greater than a reference length L_{REF} (S230). In addition, operation S130 of FIG. 3 may include when the checked data length L_{DATA} is greater than the reference length L_{REF} (S230: Yes), determining that the read operation corresponding to the received read request is the sequential read operation (S250), and when the checked data length L_{DATA} is not greater than the reference length L_{REF} (S230: No), determining that the read operation corresponding to the received read request is the random read operation (S270).

Referring to FIG. 5, the read request RQ_{READ} received from the host 300 may include a logical block address (LBA) indicating a start position of data to be read and the data length L_{DATA} of data to be read. As described above, the controller 200 may convert a start LBA received from the host 300 into a PBA indicating a position of memory cells in which data is stored. The controller 200 may specify a range of data that becomes an object of the read request RQ_{READ} through the start LBA and the data length L_{DATA}.

First, the clock frequency determiner 210 of the controller 200 checks the data length L_{DATA} included in the read request RQ_{READ} received from the host 300 (S210). When the data length L_{DATA} is greater than the predetermined reference length L_{REF} (S230: Yes), this may mean that the semiconductor memory device 100 is required to continuously performs a read operation on a plurality of successive data units in response to the read request RQ_{READ}. Therefore, in this case, the clock frequency determiner 210 determines that the read operation corresponding to the received read request is the sequential read operation (S250).

On the other hand, when the data length L_{DATA} is not greater than the predetermined reference length L_{REF} (S230: No), this may mean that the semiconductor memory device 100 is required to perform a read operation on a relatively small number of data units in response to the read request RQ_{READ}. Therefore, in this case, the clock frequency determiner 210 determines that the read operation corresponding to the received read request is the random read operation (S270).

A value of the reference length L_{REF} may be determined as various values as needed. In an embodiment, the reference length L_{REF} may be a value selected to minimize power consumed by the controller 200 while satisfying a performance value required for the storage device 1000. The value of the reference length L_{REF} may be experimentally determined according to repeated performance tests.

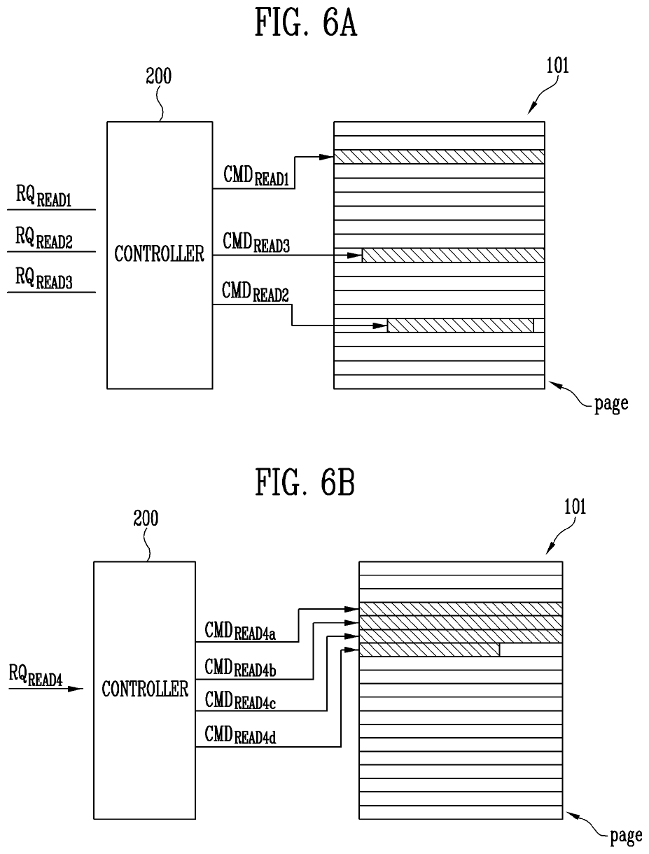

FIGS. 6A and 6B are diagrams illustrating a method of determining the type of the read operation corresponding to the received read request by the method shown in FIG. 4 according to an embodiment of the present disclosure.

Referring to FIG. 6A, an operation of the controller 200 is shown when read operations corresponding to read requests RQ_{READ1}, RQ_{READ2}, and RQ_{READ3} received from the host 300 are random reads. In FIG. 6A, only the controller 200 and a storage area 101 included in the semiconductor memory device are shown. The storage area 101 may be configured by memory cells included in the semiconductor memory device. In an embodiment, the storage area 101 may include a plurality of pages. A page may be a unit of a read operation of data.

The controller 200 receives the read requests RQ_{READ1}, RQ_{READ2}, and RQ_{READ3} from the host 300 and generates read commands CMD_{READ1}, CMD_{READ2}, and CMD_{READ3} corresponding to the read requests RQ_{READ1}, RQ_{READ2}, and RQ_{READ3}, respectively. In FIG. 6A, data of a size corresponding to one page or a size less than one page may be read by the read commands CMD_{READ1}, CMD_{READ2}, and CMD_{READ3}. That is, as shown in FIG. 6A, the data length L_{DATA} included in each of the read requests RQ_{READ1}, RQ_{READ2}, and RQ_{READ3} is less than the reference length L_{REF}. Therefore, read operations corresponding to the read requests RQ_{READ1}, RQ_{READ2}, and RQ_{READ3} respectively become random read operations.

Referring to FIG. 6B, an operation of the controller 200 when read operations corresponding to a read request RQ_{READ4} received from the host 300 are sequential reads are shown. In FIG. 6B, data corresponding to the read request RQ_{READ4} is stored across four pages. For example, when a value of the reference length L_{REF} is a value corresponding to three pages, the clock frequency determiner 210 of the controller 200 may determine that the read operation corresponding to the read request RQ_{READ4} is the sequential read operation. As another example, when the value of the reference length L_{REF} is a value corresponding to five or more pages, the clock frequency determiner 210 of the controller 200 may determine that the read operation corresponding to the read request RQ_{READ4} is the random read operation.

The controller 200 may generate a plurality of read commands CMD_{READ4a}, CMD_{READ4b}, CMD_{READ4c}, and CMD_{READ4d} based on the read request RQ_{READ4} received from the host 300. In FIG. 6B, since data corresponding to the read request RQ_{READ4} is stored across four pages, the four read commands CMD_{READ4a}, CMD_{READ4b}, CMD_{READ4c}, and CMD_{READ4d} corresponding to the four pages may be generated.

According to the embodiment described with reference to FIGS. 4 to 6B, the clock frequency determiner 210 may determine whether the corresponding read operation is the sequential read operation or the random read operation based on the data length L_{DATA} included in one read request RQ_{READ}. Meanwhile, according to another embodiment of the present disclosure, the clock frequency determiner 210 may determine whether the corresponding read operation is the sequential read operation or the random read operation based on two or more read requests RQ_{READ}.

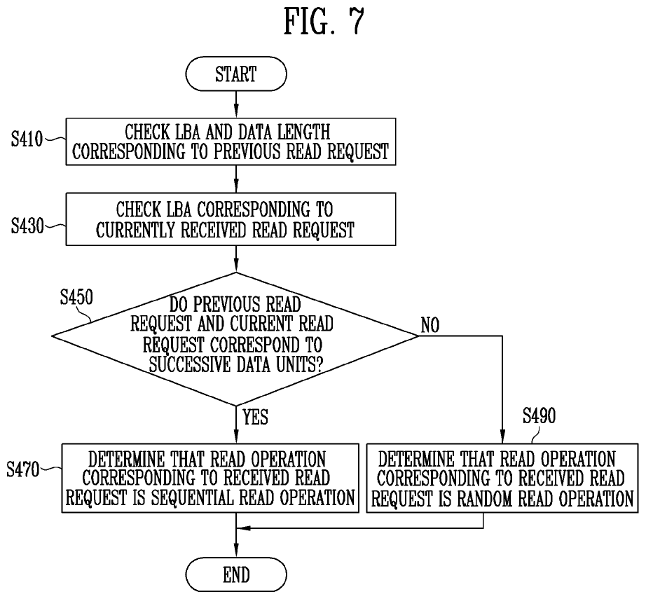

FIG. 7 is a detailed flowchart illustrating operation S130 of FIG. 3 according to an embodiment of the present disclosure.

Referring to FIG. 7, operation S130 of FIG. 3 includes checking an LBA and a data length corresponding to a previous read request (S410), checking an LBA corresponding to a currently received read request (S430), and determining whether the previous read request and the current read request correspond to successive data units (S450). In addition, operation S130 of FIG. 3 may include when the previous read request and the current read request correspond to the successive data units (S450: Yes), determining that a read operation corresponding to the currently received read request is the sequential read operation (S470), or when the previous read request and the current read request do not correspond to the successive data units (S450: No), determining that the read operation corresponding to the currently received read request is the random read operation (S490).

In operation S410, the clock frequency determiner 210 checks the LBA and data length corresponding to the previous read request. The previous read request may refer to a read request received from the host immediately before the read request current received from the host. As described with reference to FIG. 5, the read request RQ_{READ} may include the start LBA. Therefore, in operation S410, the clock frequency determiner 210 may check the start LBA corresponding to the previous read request.

In order to perform operation S410, the clock frequency determiner 210 may store the LBA and the data length included in the received read request until a next read request is received.

In operation S430, the clock frequency determiner 210 checks the LBA corresponding to the currently received read request. As described with reference to FIG. 5, the read request RQ_{READ} may include the start LBA. Therefore, in operation S430, the clock frequency determiner 210 may check the start LBA corresponding to the currently received read request.

In operation S450, the clock frequency determiner 210 determines whether the previous read request and the current read request correspond to the successive data units. This means that the clock frequency determiner 210 determines whether data specified by the previous read request and data specified by the current read request are data configuring a continuous LBA.

As described above, corresponding data may be specified through the start LBA and the data length L_{DATA} included in the read request RQ_{READ}. The data corresponding to the previous read request may be specified by operation S410. This means that a position where the data corresponding to the previous read request ends may be specified in operation S410.

That is, when the LBA of the position where the data ends specified by operation S410 is identical to the start LBA corresponding to the currently received read request, it may be determined that the previous read request and the current read request correspond to the successive data units (S450: Yes). On the other hand, when the LBA of the position where the data ends specified by operation S410 is different from the start LBA corresponding to the currently received read request, it may be determined that the previous read request and the current read request do not correspond to the successive data units (S450: No).

In another embodiment, even though the position where the data corresponding to the previous read request ends is not identical to the start LBA corresponding to the currently received read request, when a position difference between the two is small, it may be determined that the previous read request and the current read request correspond to the successive data units. For example, when a difference between the LBA indicating the position where the data corresponding to the previous read request ends and the start LBA corresponding to the currently received read request is within a predetermined range, it may be determined that the previous read request and the current read request correspond to the successive data units.

When it is determined that the previous read request and the current read request correspond to the successive data units (S450: Yes), the clock frequency determiner 210 determines that the read operation corresponding to the currently received read request is the sequential read operation (S470).

On the other hand, when it is determined that the previous read request and the current read request do not correspond to the successive data units (S450: No), the clock frequency determiner 210 determines that the read operation corresponding to the received read request is the random read operation (S490).

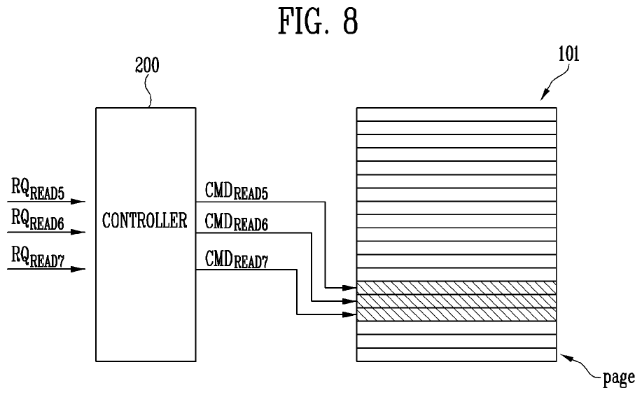

FIG. 8 is a diagram illustrating a method of determining the type of the read operation corresponding to the received read request by the method shown in FIG. 7 according to an embodiment of the present disclosure.

Referring to FIG. 8, the controller 200 sequentially receives read requests RQ_{READ5}, RQ_{READ6}, and RQ_{READ7} from the host 300. When the controller 200 receives the read request RQ_{READ5} from the host 300, since a previously received read request does not exist, it may be determined that the read operation corresponding to the read request RQ_{READ5} is the random read operation. The controller 200 generates a read command CMD_{READ5} in response to the read request RQ_{READ5}.

When the controller 200 receives the read request RQ_{READ6} from the host 300, since data specified by the previously received read request RQ_{READ5} and the currently received read request RQ_{READ6} are successive data (S450: Yes), the controller 200 may determine that the read operation corresponding to the read request RQ_{READ6} is the sequential read operation. The controller 200 generates a read command CMD_{READ6} in response to the read request RQ_{READ6}.

In addition, when the controller 200 receives the read request RQ_{READ7} from the host 300, since the data specified by the previously received read request RQ_{READ6} and the currently received read request RQ_{READ7} are successive data (S450: Yes), the controller 200 may determine that the read operation corresponding to the read request RQ_{READ7} is the sequential read operation. The controller 200 generates a read command CMD_{READ7} in response to the read request RQ_{READ7}.

FIG. 9 is a detailed flowchart illustrating operation S150 of FIG. 3 according to an embodiment of the present disclosure.

Referring to FIG. 9, operation S150 of FIG. 3 includes checking a type of a read operation to be performed by the semiconductor memory device 100 in response to a received read request (S510) and determining whether the read operation to be performed by the semiconductor memory device 100 is a sequential read operation (S530). In addition, operation S150 of FIG. 3 includes when the read operation to be performed by the semiconductor memory device 100 is the sequential read operation (S530: Yes), determining a first value as a clock frequency of a clock to be transferred to a command generator (S550), or when the read operation to be performed by the semiconductor memory device 100 is the random read operation (S530: No), determining a second value greater than the first value as the clock frequency of the clock to be transferred to the command generator (S570).

Referring to operations S510, S530, S550, and S570 of FIG. 9, when the type of the read operation determined in operation S130 is the sequential read operation (S530: Yes), the clock frequency determiner 210 determines the relative small first value as the clock frequency of the clock to be transferred to the command generator 250 (S550), and when the type of read operation determined in operation S130 is the random read operation (S530: No), the frequency determiner 210 determines the relatively large second value as the clock frequency of the clock to be transferred to the command generator 250 (S570).

Therefore, when generating the read command CM DREAD corresponding to the random read operation, the command generator 250 operates based on the clock CLK having a relatively high frequency, for example, a frequency of 600 MHz. Accordingly, the command generator 250 may rapidly generate the read commands CMD_{READ} required for the random read operation requiring high processing performance, for example, 400K IOPS. In addition, when generating the read command CMD_{READ} corresponding to the sequential read operation, the command generator 250 operates based on the clock CLK having a relatively low frequency, for example, a frequency of 400 MHz. Accordingly, the command generator 250 may maintain low power consumption while satisfying an operation condition of a large read request of, for example, 4,200 megabinary bytes per second (MiB/s) level.

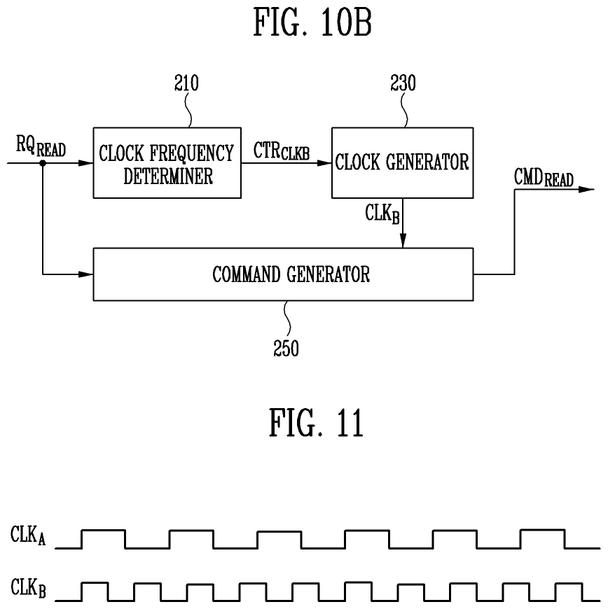

FIGS. 10A and 10B are detailed block diagrams illustrating the controller 200 generating different clock frequencies according to the type of the read operation corresponding to the received read request according to an embodiment of the present disclosure.

Referring to FIG. 10A, an example of an operation when the clock frequency determiner 210 determines that the read operation corresponding to the received read request RQ_{READ} is the sequential read operation is shown. The clock frequency determiner 210 determines that the read operation corresponding to the received read request RQ_{READ} is the sequential read operation, and determines a relatively low first value as a frequency of a clock CLK_{A} transferred to the command generator 250 according to the determination. The clock frequency determiner 210 generates a control signal CTR_{CLKA} that controls the clock generator 230 to generate the clock CLK_{A} having the frequency corresponding to the first value. The generated control signal CTR_{CLKA} is transferred to the clock generator 230. The clock generator 230 generates the clock CLK_{A} having the frequency corresponding to the first value based on the control signal CTR_{CLKA}. The clock CLK_{A} is transferred to the command generator 250, and the command generator 250 generates the read command CM DREAD corresponding to the read request RQ_{READ} based on the clock CLK_{A}.

Referring to FIG. 10B, an example of an operation when the clock frequency determiner 210 determines that the read operation corresponding to the received read request RQ_{READ} is the random read operation is shown. The clock frequency determiner 210 determines that the read operation corresponding to the received read request RQ_{READ} is the random read operation, and determines a relatively high second value as a frequency of a clock CLK_{B} transferred to the command generator 250 according to the determination. The clock frequency determiner 210 generates a control signal CTR_{CLKB} that controls the clock generator 230 to generate the clock CLK_{B} having the frequency corresponding to the second value. The generated control signal CTR_{CLKB} is transferred to the clock generator 230. The clock generator 230 generates the clock CLK_{B} having the frequency corresponding to the second value based on the control signal CTR_{CLKB}. The clock CLK_{B} is transferred to the command generator 250, and the command generator 250 generates the read command CMD_{READ} corresponding to the read request RQ_{READ} based on the clock CLK_{B}.

FIG. 11 is waveforms illustrating the clocks shown in FIGS. 10A and 10B according to an embodiment of the present disclosure.

Referring to FIG. 11, the clock CLK_{A} generated by the clock generator 230 when it is determined that the read operation corresponding to the received read request RQ_{READ} is the sequential read operation and the clock CLK_{B} generated by the clock generator 230 when it is determined that the read operation corresponding to the received read request RQ_{READ} is the random read operation are shown. As shown in FIG. 11, a frequency of the clock CLK_{B} is relatively higher than that of the clock CLK_{A}. That is, when it is determined that the read operation corresponding to the received read request RQ_{READ} is the random read operation, the command generator 250 generates the read command CM DREAD based on the clock CLK_{B} having a relatively high frequency. Accordingly, the command generator 250 may rapidly generate the read commands CMD_{READ} required for the random read operation requiring high processing performance. When it is determined that the read operation corresponding to the received read request RQ_{READ} is the sequential read operation, the command generator 250 generates the read command CMD_{READ} based on the clock CLK_{A} having a relatively low frequency. Accordingly, the command generator 250 may generate the read command CM DREAD while maintaining low power consumption while satisfying an operating condition of a large read request.

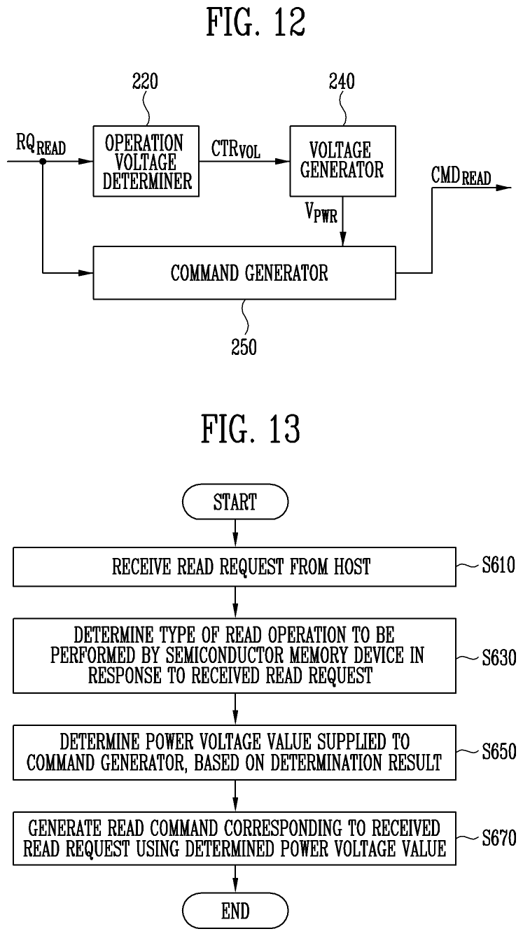

FIG. 12 is a detailed block diagram illustrating a controller according to another embodiment of the present disclosure. FIG. 13 is a flowchart illustrating a method of operating a controller according to another embodiment of the present disclosure.

Hereinafter, with reference to FIGS. 12 and 13, the controller 200 and a method of operation the same according to an embodiment of the present disclosure are described.

Referring to FIG. 12, the controller 200 according to an embodiment of the present disclosure may include an operation voltage determiner 220, a voltage generator 240, and the command generator 250. Referring to FIG. 13, a method of operating a controller according to an embodiment of the present disclosure includes receiving a read request from a host (S610), determining a type of a read operation to be performed by a semiconductor memory device in response to the received read request (S630), determining a value of a power voltage value supplied to the command generator 250 based on a determination result (S650), and generating a read command corresponding to the received read request using the determined power voltage value (S670).

In FIG. 12, the operation voltage determiner 220 determines the type of the corresponding read operation based on the read request RQ_{READ} received from the host 300 (S610) (S630), and determines the power voltage value supplied to the command generator according to the determination result (S650). The operation voltage determiner 220 generates a control signal CTR_{VOL} for controlling an operation of the voltage generator 240 according to the determined power voltage value.

More specifically, the operation voltage determiner 220 analyzes the read request RQ_{READ} received from the host 300 and determines whether the read operation corresponding to the read request RQ_{READ} is the random read operation or the sequential read operation. Specific embodiments in which the operation voltage determiner 220 determines whether the corresponding read operation is the random read operation or the sequential read operation based on the read request RQ_{READ} (S630) have been described with reference to FIGS. 4 to 8.

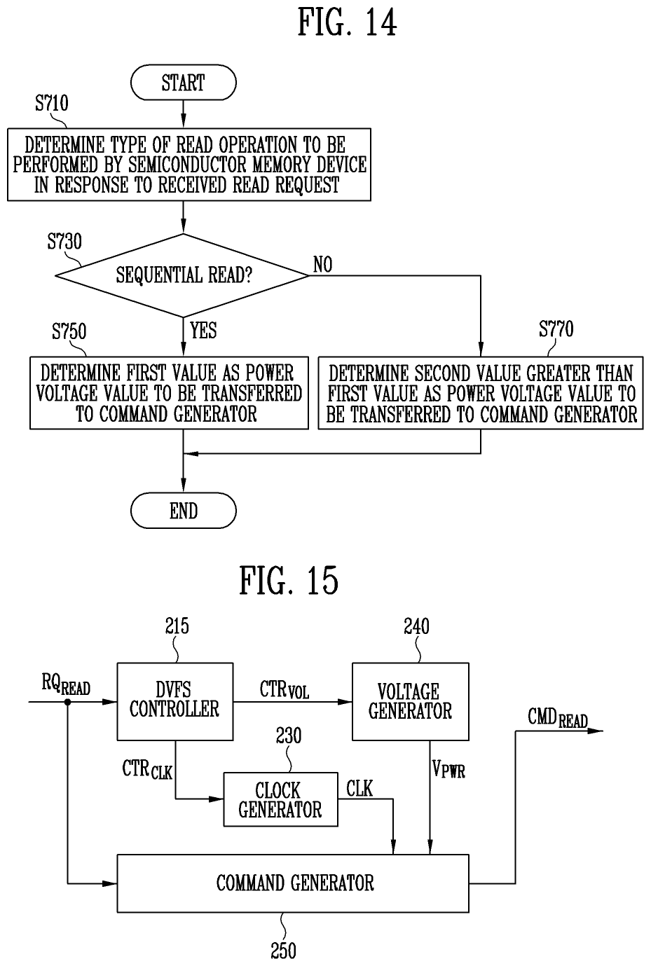

The operation voltage determiner 220 determines the power voltage value based on whether the read operation corresponding to the read request RQ_{READ} is the random read operation or the sequential read operation. A specific embodiment in which the operation voltage determiner 220 determines the power voltage value is described with reference to FIG. 14.

The voltage generator 240 generates a power voltage V_{PWR} based on the received control signal CTR_{VOL}. The generated power voltage V_{PWR} is transferred to the command generator 250.

The command generator 250 receives the read request RQ_{READ} and the power voltage V_{PWR}. The command generator 250 generates the read command corresponding to the received read request RQ_{READ} using the received power voltage V_{PWR} (S670).

Nodes between circuit elements configuring the command generator 250 have a certain amount of capacitance. In a given amount of capacitance, since the capacitance is rapidly charged and discharged when the circuit elements are operated with a high voltage, an operation speed of the circuit elements may be improved. That is, in order to increase an operation speed of the command generator 250, a magnitude of the power voltage V_{PWR} supplied to the command generator 250 is required to be increased. However, as the magnitude of the power voltage V_{PWR} supplied to the command generator 250 increases, power consumed by the command generator 250 also increases.

The controller according to another embodiment of the present disclosure determines the type of the corresponding read operation based on the read request RQ_{READ} received from the host 300 and determines an operation voltage used for generating the read command CMD_{READ} according to the determination. Therefore, the magnitude of the power voltage transferred to the command generator 250 may be optimized according to the type of the read operation. As a result, power consumed by the controller 200 may be minimized while satisfying a performance requirement according to the characteristic of the read operation.

FIG. 14 is a detailed flowchart illustrating operation S650 of FIG. 13 according to an embodiment of the present disclosure.

Referring to FIG. 14, operation S650 of FIG. 13 includes checking the type of the read operation to be performed by the semiconductor memory device 100 in response to the received read request (S710) and determining whether the read operation to be performed by the semiconductor memory device 100 is the sequential read operation (S730). In addition, operation S650 of FIG. 13 includes when the read operation to be performed by the semiconductor memory device 100 is the sequential read operation (S730: Yes), determining a first value as the power voltage value to be supplied to the command generator (S750) or when the read operation to be performed by the semiconductor memory device 100 is the random read operation (S730: No), determining a second value greater than the first value as the power voltage value to be supplied to the command generator (S770).

Referring to operations S710, S730, S750, and S770 of FIG. 14, when the type of the read operation determined in operation S630 is the sequential read operation (S730: Yes), the operation voltage determiner 220 determines the relative small first value as the power voltage value to be supplied to the command generator 250 (S750), and when the type of the read operation determined in operation S630 is the random read operation (S730: No), the operation voltage determiner 220 determines the relatively large second value as the power voltage value to be supplied to the command generator 250 (S770).

With reference to FIGS. 2 to 11, an embodiment in which the frequency of the clock transferred to the command generator is determined according to the type of the read operation has been described, and with reference to FIGS. 12 to 14, an embodiment in which the magnitude of the power voltage supplied to the command generator is determined according to the type of the read operation has been described. However, the present disclosure is not limited thereto, and an embodiment in which both of the frequency of the clock transferred to the command generator and the magnitude of the power voltage supplied to the command generator are determined according to the type of the read operation is also possible. Hereinafter, the disclosure is described with reference to FIG. 15.

FIG. 15 is a detailed block diagram illustrating a controller according to still another embodiment of the present disclosure.

Referring to FIG. 15, the controller 200 according to an embodiment of the present disclosure may include a dynamic voltage and frequency scaling (DVFS) controller 215, the clock generator 230, the voltage generator 240, and the command generator 250.

The DVFS controller 215 determines the type of the corresponding read operation based on the read request RQ_{READ} received from the host 300. The DVFS controller 215 determines the frequency of the clock CLK transferred to the command generator 250 and the value of the power voltage V_{PWR} supplied to the command generator 250 according to the determination result. The DVFS controller 215 generates the control signal CTR_{CLK} for controlling the clock generator 230 to generate the clock CLK according to the determined frequency and the control signal CTR_{VOL} for controlling the voltage generator 240 to generate the power voltage V_{PWR} according to the determined value.

More specifically, the DVFS controller 215 analyzes the read request RQ_{READ} received from the host 300 and determines whether the read operation corresponding to the read request RQ_{READ} is the random read operation or the sequential read operation. Specific embodiments in which the DVFS controller 215 determines whether the corresponding read operation is the random read operation or the sequential read operation based on the read request RQ_{READ} (S630) have been described with reference to FIGS. 4 to 8.

When the read operation corresponding to the read request RQ_{READ} is the sequential read operation, the DVFS controller 215 controls the clock generator 230 to generate a clock CLK having a relatively low frequency and controls the voltage generator 240 to generate a power voltage V_{PWR} of a relatively small value. On the other hand, when the read operation corresponding to the read request RQ_{READ} is the random read operation, the DVFS controller 215 controls the clock generator 230 to generate a clock CLK having a relatively high frequency, and controls the voltage generator 240 to generate a power voltage V_{PWR} of a relatively large value.

As described above, the controller according to still another embodiment of the present disclosure determines the type of the corresponding read operation based on the read request RQ_{READ} received from the host 300 and determines the frequency of the clock and the power voltage value used for generating the read command CM DREAD. Therefore, the magnitude of the power voltage and the frequency of the clock signal transferred to the command generator 250 may be optimized according to the type of the read operation. As a result, power consumed by the controller 200 may be minimized while satisfying a performance requirement according to the characteristic of the read operation.

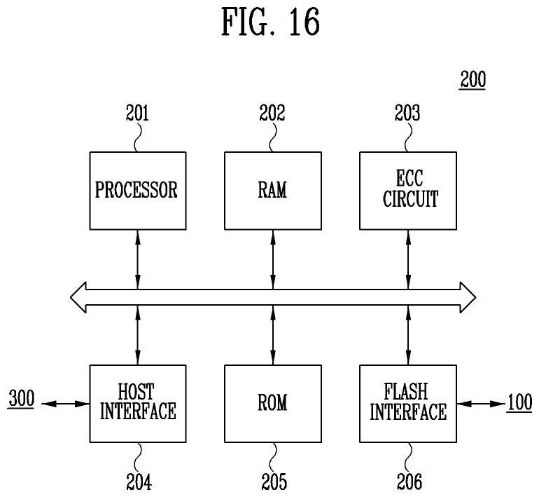

FIG. 16 is a detailed diagram illustrating a controller 200 according to an embodiment of the present disclosure.

Referring to FIG. 16, the controller 200 may include a processor 201, a RAM 202, an error correction circuit (ECC circuit) 203, a host interface 204, a ROM 205, and a flash interface 206.

The processor 201 may control an overall operation of the controller 200. At least a portion of the clock frequency determiner 210 of FIG. 2, the operation voltage determiner of FIG. 12, and the DVFS controller 215 of FIG. 15 may be implemented as firmware (FW) executed by the processor 201 of FIG. 16.

The RAM 202 may be used as a buffer memory, a cache memory, an operation memory, and the like of the controller 200. For example, the RAM 202 may be a buffer memory.

The error correction circuit 203 may generate an error correction code (ECC) for correcting a fail bit or an error bit of data received from the semiconductor memory device 100.

The error correction circuit 203 may perform error correction encoding of data provided to the semiconductor memory device 100 to generate data to which a parity bit is added. The parity bit (not shown) may be stored in the semiconductor memory device 100. The error correction circuit 203 may perform error correction decoding on the data output from the semiconductor memory device 100, and at this time, the error correction circuit 203 may correct an error using parity. For example, the error correction circuit 203 may correct the error using various coded modulations such as an LDPC code, a BCH code, a turbo code, a Reed-Solomon code, a convolution code, an RSC, a TCM, and a BCM.

The error correction circuit 203 may calculate an error correction code value of data to be programmed to the semiconductor memory device 100 in the program operation. The error correction circuit 203 may perform an error correction operation based on the error correction code value on data read from the semiconductor memory device 100 in the read operation. The error correction circuit 203 may perform an error correction operation of data recovered from the semiconductor memory device 100 in a recovery operation of failed data.

The controller 200 may communicate with an external device (for example, the host 300, an application processor, and the like) through the host interface 204.

The ROM 205 may store various pieces of information required to operate the controller 200 in a firmware form.

The controller 200 may communicate with the semiconductor memory device 100 through the flash interface 206. The controller 200 may transmit the command CMD, the address ADDR, a control signal CTRL, and the like to the semiconductor memory device 100 and receive data through the flash interface 206.

For example, the flash interface 206 may include a NAND interface.

In an embodiment, at least a portion of the command generator 250 of FIGS. 2, 12, and 15 may be implemented as firmware (FW) executed by the processor 201 of FIG. 16. In another embodiment, at least a portion of the command generator 250 of FIGS. 2, 12, and 15 may be included in the flash interface 206 of FIG. 16.

The clock generator 230 of FIGS. 2 and 15 may be implemented as a separate component except for the components shown in FIG. 16. In addition, the voltage generator of FIGS. 12 and 15 may also be implemented as a separate component except for the components shown in FIG. 16.

The embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein and the following claims. Furthermore, the embodiments may be combined to form additional embodiments.

What is claimed is:

1. A controller comprising:
a clock frequency determiner configured to:
determine a type of a read operation corresponding to a read request based on the read request received from a host, and
determine a clock frequency according to the type;
a clock generator configured to generate a clock according to the determined clock frequency; and
a command generator configured to generate, using the clock, a read command corresponding to the read request.

2. The controller of claim 1, wherein the type of the read operation is one of a random read operation and a sequential read operation.

3. The controller of claim 2,
wherein the read request includes a start logical block address and a data length, and
wherein the clock frequency determiner determines the type of the read operation as the sequential read operation when the data length is greater than a predetermined reference length, and as the random read operation when the data length is not greater than the predetermined reference length.

4. The controller of claim 2,
wherein the read request includes a start logical block address and a data length, and
wherein the clock frequency determiner determines the type of the read operation as the sequential read operation when a previous read request and the received read request correspond to successive data units, and as the random read operation when the previous read request and the received read request do not correspond to the successive data units.

5. The controller of claim 4, wherein the clock frequency determiner is further configured to:
calculate, based on the start logical block address and the data length of the previous read request, a logical block address of a position where data corresponding to the previous read request ends, and
determine the previous read request and the received read request to correspond to the successive data units when the logical block address of the position where the data corresponding to the previous read request ends is identical to the start logical block address of the received read request.

6. The controller of claim 2, wherein the clock generator generates the clock having a frequency of a first value when the clock frequency determiner determines the type of the read operation as the random read operation, and generates the clock having a frequency of a second value less than the first value when the clock frequency determiner determines the type of the read operation as the sequential read operation.

7. A controller comprising:
an operation voltage determiner configured to:
determine a type of a read operation corresponding to a read request based on the read request received from a host, and
determine an operation voltage according to the type;
a voltage generator configured to generate a power voltage according to the determined operation voltage; and
a command generator configured to generate, using the power voltage, a read command corresponding to the read request.

8. The controller of claim 7, wherein the type of the read operation is one of a random read operation and a sequential read operation.

9. The controller of claim 8, wherein the voltage generator:
generates the power voltage having a first value when the operation voltage determiner determines the type of the read operation as the random read operation, and
generates the power voltage having a second value less than the first value when the operation voltage determiner determines the type of the read operation as the sequential read operation.

10. A method of operating a controller, the method comprising:
receiving a read request from a host;
determining a type of a read operation to be performed in response to the read request; and
determining, based on the determined type, at least one of a clock frequency and a power voltage value to be used for command generation.

11. The method of claim 10, wherein the determining the type of the read operation comprises:
checking a data length included in the read request; and
determining the type of the read operation based on whether the checked data length is greater than a reference length.

12. The method of claim 11, wherein the type of the read operation is determined as a sequential read operation when the checked data length is greater than the reference length.

13. The method of claim 11, wherein the type of the read operation is determined as a random read operation when the checked data length is not greater than the reference length.

14. The method of claim 10, wherein the determining the type of the read operation comprises:
checking a start logical block address and a data length corresponding to a previous read request;
checking a start logical block address corresponding to the received read request; and
determining the type of the read operation based on whether the previous read request and the received read request correspond to successive data units.

15. The method of claim 14, wherein the determining the type of the read operation based on whether the previous read request and the received read request correspond to the successive data units comprises:
calculating, based on the checked start logical block address and the checked data length corresponding to the previous read request, a logical block address of a position where data corresponding to the previous read request ends; and
determining whether the calculated logical block address of the position where the data corresponding to the previous read request ends is identical to the checked start logical block address corresponding to the received read request.

16. The method of claim 15, wherein the type of the read operation is determined as a sequential read operation when the calculated logical block address of the position where the data corresponding to the previous read request ends is identical to the checked start logical block address corresponding to the received read request.

17. The method of claim 15, wherein the type of the read operation is determined as a random read operation when the calculated logical block address of the position where the data corresponding to the previous read request ends is not identical to the checked start logical block address corresponding to the received read request.

18. The method of claim 10, wherein the determining at least one of the clock frequency and the power voltage value comprises determining, as a relatively small first value, the clock frequency when the type of the read operation is determined as a sequential read operation.

19. The method of claim 10, wherein the determining at least one of the clock frequency and the power voltage value comprises determining, as a relatively large second value, the clock frequency when the type of the read operation is determined as a random read operation.

20. The method of claim 10, wherein the determining at least one of the clock frequency and the power voltage value comprises determining, as a relatively small first value, the power voltage value when the type of the read operation is determined as a sequential read operation.

21. The method of claim 10, wherein the determining at least one of the clock frequency and the power voltage value comprises determining, as a relatively large second value, the power voltage value when the type of the read operation is determined as a random read operation.

22. The method of claim 10, further comprising generating the command using the determined one of the clock frequency and the power voltage value.
